(19) United States
(12) Patent Application Publication
(10) Pub. No.: US 2025/0173019 A1
(43) Pub. Date: May 29, 2025

(54) ELECTRONIC APPARATUS

(71) Applicant: Innolux Corporation, Miaoli County (TW)

(72) Inventors: Chung-Le Chen, Miaoli County (TW); Shuo-Ting Hong, Miaoli County (TW); Hung-Kun Chen, Miaoli County (TW); Cheng-Tso Chen, Miaoli County (TW)

(73) Assignee: Innolux Corporation, Miaoli County (TW)

(21) Appl. No.: 18/923,711

(22) Filed: Oct. 23, 2024

(30) Foreign Application Priority Data
Nov. 23, 2023 (CN) 202311574872.4

(51) Int. Cl. G06F 3/041; G06F 3/044

(52) U.S. Cl. CPC G06F 3/041661; G06F 3/0446

(57) ABSTRACT

An electronic apparatus includes a substrate, a plurality of scan lines, and a plurality of first switching units. The plurality of scan lines are disposed on the substrate. The plurality of first switching units are disposed on the substrate. Each scan line is coupled to the driver device through one of the plurality of first switching units.

### CROSS-REFERENCE TO RELATED APPLICATION

This application claims the priority benefit of China application serial no. 202311574872.4, filed on Nov. 23, 2023. The entirety of the above-mentioned patent application is hereby incorporated by reference herein and made a part of this specification.

### BACKGROUND

### Technical Field

The disclosure relates to an electronic apparatus, and in particular, to an electronic apparatus with a touch sensing function.

### Description of Related Art

The electronic apparatus can be equipped with a touch sensing function, allowing users to input information or instructions from the display interface through touch to provide a better user experience. The driver device is used to scan the electronic apparatus to drive the electronic apparatus to perform sending and receiving electromagnetic wave signals, display functions, and/or touch sensing functions. However, when the driver device scans the electronic apparatus, the driver device coupled to the scan line may experience different equivalent capacitance values or load values due to capacitance effects or load effects, thus affecting the touch sensing result of the electronic apparatus.

### SUMMARY

The disclosure provides an electronic apparatus, including a substrate, a plurality of scan lines, and a plurality of first switching units. The plurality of scan lines are disposed on the substrate. The plurality of first switching units are disposed on the substrate. Each scan line is coupled to the driver device through one of the plurality of first switching units.

### BRIEF DESCRIPTION OF THE DRAWINGS

FIG. 1 shows a schematic outline diagram of an electronic apparatus of an embodiment of the disclosure.

FIG. 2 shows a schematic outline diagram of touch electrodes and pixels of the electronic apparatus of the embodiment of FIG. 1.

FIG. 3A shows a schematic circuit diagram of the electronic apparatus of the embodiment of FIG. 1.

FIG. 3B shows a schematic waveform diagram of signals of the electronic apparatus of the embodiment of FIG. 3A.

FIG. 4A shows a schematic outline diagram of a driver device of an embodiment of the disclosure.

FIG. 4B shows a schematic waveform diagram of signals related to the driver device of the embodiment of FIG. 4A.

FIG. 5 shows a schematic diagram of a partial circuit structure of the driving units in the driver device of the embodiment of FIG. 4A.

FIG. 6A shows a schematic outline diagram of an electronic apparatus of another embodiment of the disclosure.

FIG. 6B shows a schematic circuit diagram of the electronic apparatus of the embodiment of FIG. 6A.

### DESCRIPTION OF THE EMBODIMENTS

The disclosure can be understood by referring to the following detailed description in conjunction with the drawings. It should be noted that in order to facilitate the understanding of the reader and the simplicity of the drawings, the multiple drawings in the disclosure only depict a portion of an electronic apparatus, and specific elements in the drawings are not drawn according to actual scale. In addition, the number and the size of each element in the drawings are for illustration only and are not intended to limit the scope of the disclosure.

In the following description and claims, the words “comprising” and “including” are open-ended words, and thus should be interpreted as meaning “including but not limited to . . . ”.

It should be understood that although the terms first, second, third . . . may be used to describe various constituent elements, the constituent elements are not limited by such terms. This term is only used to distinguish a single constituent element from other constituent elements in the specification. The same terms may not be used in the claims, but replaced by first, second, third . . . in the order in which the elements are mentioned in the claims. Therefore, in the following description, the first constituent element may be the second constituent element in the claims.

In some embodiments of the disclosure, terms related to joining and connecting, such as “connected”, “interconnected”, etc., unless otherwise defined, may mean that the two structures are in direct contact, or may also mean that the two structures are not in direct contact, and there are other structures located between these two structures. And the terms regarding joining and connecting may also refer to the circumstances where both structures are movable, or both structures are fixed. Furthermore, the term “coupled” refers to any direct and indirect means of electrical connection. In the case of direct electrical connection, the terminals of elements on two circuits are directly connected or connected to each other by a conductor line, and in the case of indirect electrical connection, there are switches, diodes, capacitors, inductors, resistors, other suitable elements, or a combination of the above-mentioned elements between the terminals of the elements on the two circuits, but the disclosure is not limited thereto.

An electronic apparatus of the disclosure may include a display device, an antenna device, a sensing device, a light-emitting device, or a splicing device, but not limited thereto. The electronic apparatus may include a bendable or flexible electronic apparatus. The electronic apparatus may include an electronic unit. The electronic apparatus includes, for example, a liquid crystal layer or a light-emitting diode (LED). The electronic unit may include a passive element and an active element, such as a capacitor, a resistor, an inductor, an electrode, a liquid crystal cell, a variable capacitor, a filter, a diode, a transistor, a sensor, an MEMS, a liquid crystal chip, a controller, etc., but not limited thereto. The diode may include a light-emitting diode or a photodiode. The light-emitting diode may include, for example, an organic light-emitting diode (OLED), a mini LED, a micro LED, a quantum dot LED, fluorescence, phosphor, or other suitable materials, or a combination thereof, but not limited thereto. The sensor may include, for example, a capacitive sensor, an optical sensor, an electromagnetic sensor, a fingerprint sensor (FPS), a touch sensor, an antenna, or a pen sensor, etc., but not limited thereto. The controller may include, for example, a timing controller, but not limited thereto. In the following, a display device will be used as an electronic apparatus to illustrate the disclosure, but the disclosure is not limited thereto.

Reference will now be made in detail to the present embodiments of the disclosure, examples of which are illustrated in the accompanying drawings. Whenever possible, the same reference numbers are used in the drawings and description to refer to the same or like parts.

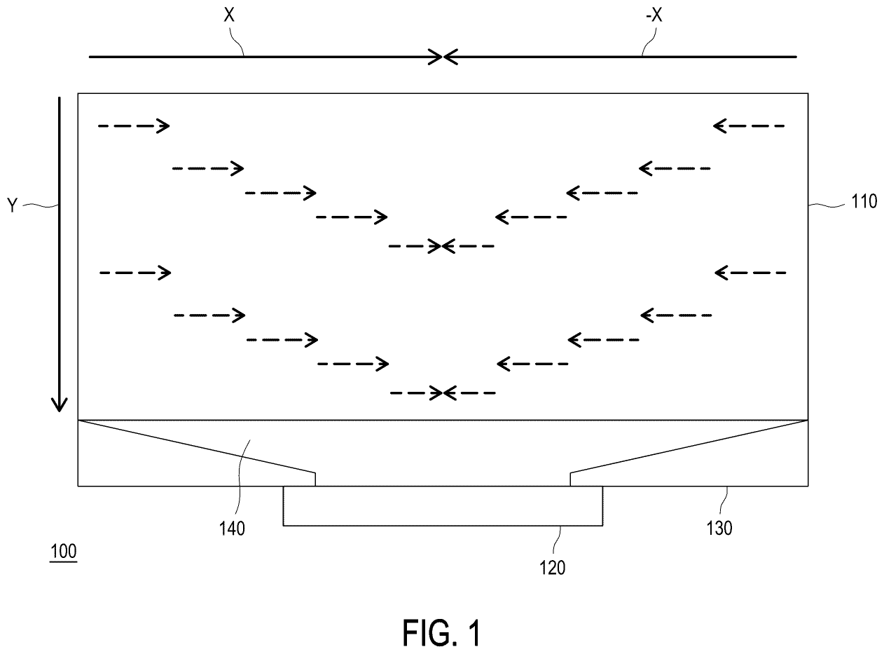

FIG. 1 shows a schematic outline diagram of an electronic apparatus of an embodiment of the disclosure. Referring to FIG. 1, an electronic apparatus 100 has a display function and a touch sensing function. The electronic apparatus 100 includes a substrate 110, a plurality of signal lines (not shown), and a plurality of switching units (not shown). The signal lines and the switching units are disposed on the substrate 110. The electronic apparatus 100 may further include a plurality of electronic units (not shown) disposed on the substrate 110, and each electronic unit may be coupled to one of the plurality of signal lines. The substrate 110 is, for example, a base plate of a display panel with a touch function, but not limited thereto. The electronic apparatus 100 may further include a control element 120 configured to drive the electronic unit on the substrate 110 to perform the display function and/or the touch sensing function. The control element 120 is, for example, an integrated circuit chip integrating display control function and/or touch control function. The control element 120 may be disposed outside the substrate 110 and coupled to the electronic unit on the substrate 110 through a signal line 140 on a wiring area 130 of the substrate 110.

Specifically, the control element 120 scans from above to below the substrate 110 at a frequency of, for example, 60 Hz, as shown in a direction Y, to drive a corresponding first electronic unit on the substrate 110 to perform the display function. The control element 120 scans from the two outer sides to the inner side of the substrate 110 at, for example, a frequency of 120 Hz, as shown in a direction X and a direction −X, to drive a corresponding second electronic unit on the substrate 110 to perform the touch sensing function.

The number of the control element 120 is not intended to limit the disclosure. In another embodiment, the electronic apparatus 100 may also include a plurality of control elements 120 to respectively drive electronic units in different areas on the substrate 110 to perform the display function and/or the touch sensing function.

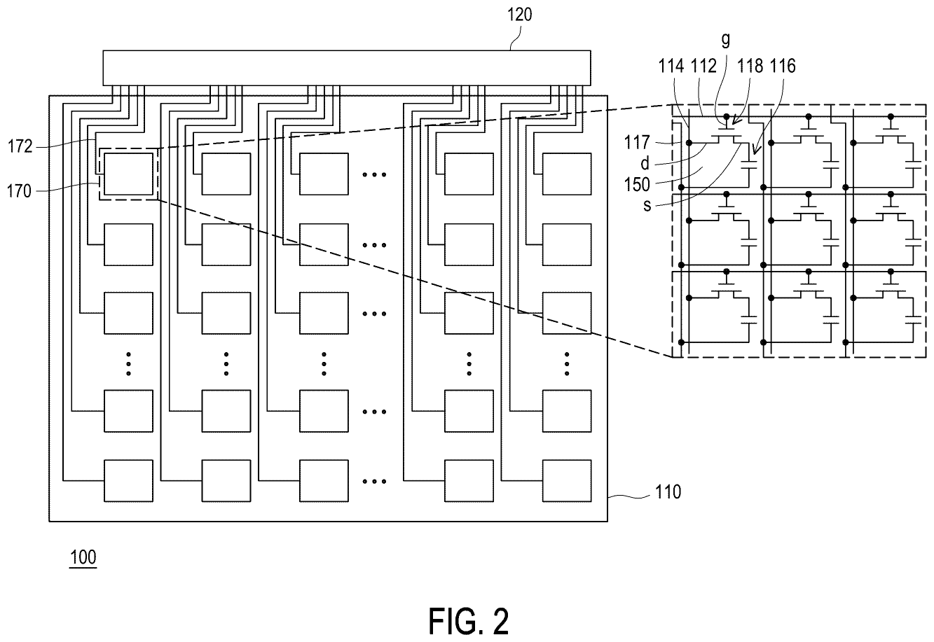

FIG. 2 shows a schematic outline diagram of touch electrodes and pixels of the electronic

apparatus of the embodiment of FIG. 1. Referring to FIG. 2, the electronic apparatus 100 may include a plurality of electronic units 116, and each electronic unit 116 may be disposed in a pixel 150. In an embodiment, the electronic unit may be a liquid crystal cell. In another embodiment, the electronic unit may be a diode, but not limited thereto. The electronic apparatus 100 also includes at least one touch electrode 170. The touch electrode 170 may be coupled to the control element 120 through a signal line 172. The electronic unit 116 included in each pixel can be coupled to a switching unit 118. In an embodiment, the switching unit 118 may be, for example, a thin film transistor (TFT) having a gate g, a source s, and a drain d. The gate g is coupled to a signal line 112, the source s is coupled to the electronic unit 116, and the drain d is coupled to a signal line 114. When the gate g of the switching unit 118 receives the signal transmitted on the signal line 112 and is turned on, the switching unit 118 can transmit the signal transmitted from the signal line 114 to the source s via the drain d of the switching unit 118 and then provide the same to the electronic unit 116. The electronic unit 116 may be coupled to a signal line 117. The signal line 117 may transmit a common signal. The range of the pixel 150 may be defined by adjacent signal lines 112 and adjacent signal lines 114. In this disclosure, adjacent signal lines 112 mean that no other signal lines 112 are disposed therebetween. The control element 120 may be configured to drive the touch electrode 170 to perform the touch sensing function. In the top view direction of the electronic apparatus 100, each touch electrode 170 may be overlapped with a plurality of pixels 150. In the embodiment, one touch electrode 170 may be overlapped with nine pixels 150 for illustration, but the disclosure is not limited thereto. In other embodiments, one touch electrode 170 may also be overlapped with N×M pixels 150, where N may be equal to M, or N may not be equal to M.

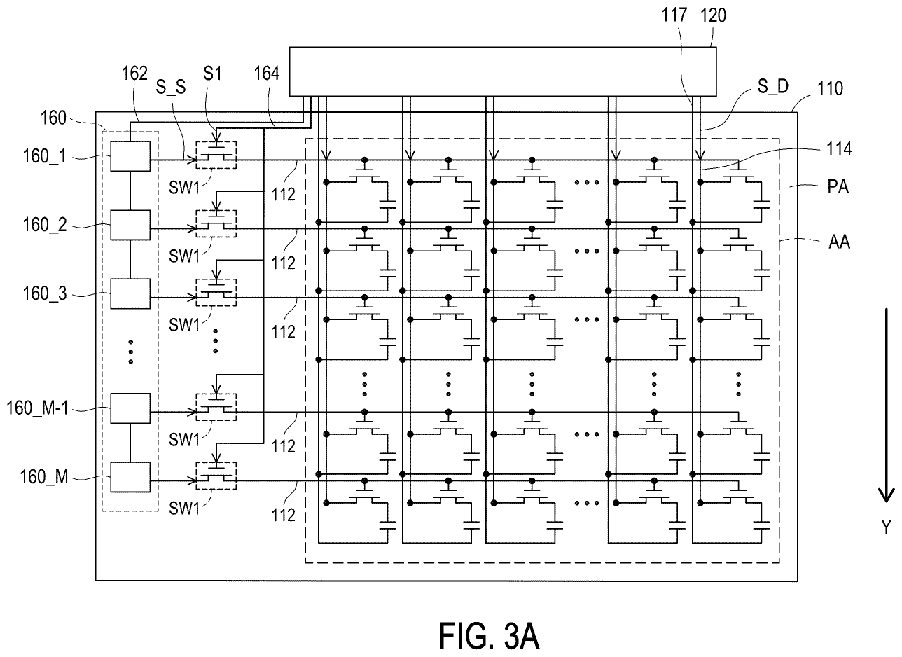

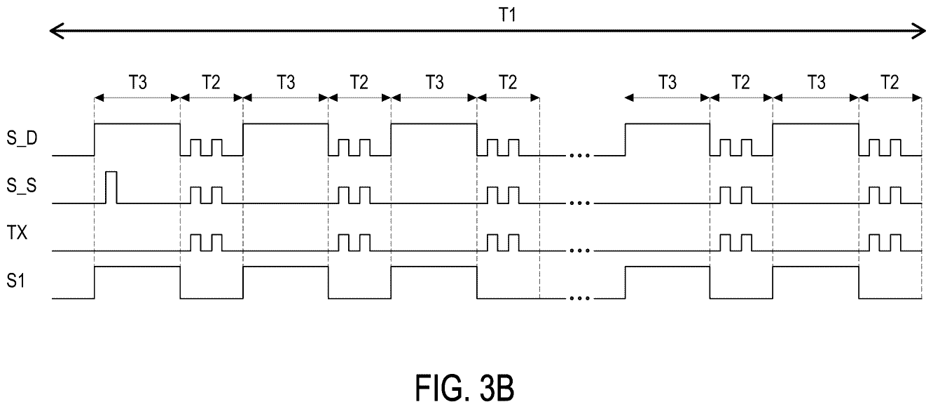

FIG. 3A shows a schematic circuit diagram of the electronic apparatus of the embodiment of FIG. 1. FIG. 3B shows a schematic waveform diagram of signals of the electronic apparatus of the embodiment of FIG. 3A. Referring to FIG. 3A and FIG. 3B, the electronic apparatus 100 includes the substrate 110, a plurality of signal lines 112, and a plurality of first switching units SW1. The signal lines 112 are, for example, scan lines for transmitting scan signals, and the signal lines 112 and the first switching units SW1 are disposed on the substrate 110. Each signal line 112 is coupled to a corresponding driving unit in a driver device 160 through one of the first switching units SW1. That is to say, a driving unit 160_1 is coupled to a first signal line 112, and a driving unit 160_2 is coupled to a second signal line 112. The direction Y in which the first signal line 112 and the second signal line 112 are arranged may be the scan direction of the electronic apparatus 100, but not limited thereto. The electronic apparatus 100 may further include a plurality of signal lines 114. The plurality of signal lines 114 are, for example, data lines for transmitting data signals.

Specifically, the substrate 110 includes a peripheral area PA and an active area AA. The electronic apparatus 100 may include the driver device 160. The first switching units SW1 and the driver device 160 are disposed in the peripheral area PA. In the embodiment, the driver device 160 may be a circuit structure directly fabricated on the substrate 110 through a semiconductor process. Alternatively, in another embodiment, the driver device 160 may be first fabricated as an integrated circuit chip and then disposed on the substrate 110. Alternatively, in another embodiment, the driver device 160 may be first fabricated as an integrated circuit chip and disposed on a circuit board, and then the circuit board is coupled to the substrate 110 through signal lines on the peripheral area of the substrate 110, but the disclosure is not limited thereto.

In the embodiment, scan lines are used as the signal lines 112 and data lines are used as the signal lines 114 to illustrate the disclosure. The driver device 160 is coupled to the control element 120. The control element 120 may output a timing signal (not shown) to the driver device 160 through a signal line 162. The control element 120 can be coupled to the plurality of first switching units SW1 through the signal line 164, and can output a switching control signal S1 to control the plurality of first switching units SW1. In an embodiment, the control element 120 may output a plurality of timing signals (not shown) and respectively provide them to the driver device 160 through different signal lines. The driver device 160 generates a scan signal S_S to the scan line 112 according to the control signal. The control unit 120 may also output a data signal S_D to the data line 114.

In FIG. 3B, T1 is a frame period, T2 is a touch sensing period, and T3 is a display update period. The electronic apparatus 100 may perform the display update function in segments and perform the touch sensing function in segments during the frame period T1. Specifically, when the electronic apparatus 100 operates during the display update period T3, the display screen data can be updated by region, and when the electronic apparatus 100 operates during the touch sensing period T2, the touch sensing function can be performed by region. During the touch sensing period T2, the control element 120 outputs a scan signal TX to the touch electrode 170 through the signal line 172, and receives a sensing signal from the touch electrode 170 through the signal line 172. Due to the electrical coupling effect, the waveform of the scan signal S_S on the scan line 112 and the waveform of the data signal S_D on the data line 114 are the same as the scan signal TX.

In the embodiment, the conduction states of the first switching units SW1 are controlled by the switching control signal S1. In the embodiment, the first switching units SW1 are N-type switching units, but not limited thereto. During the display update period T3, the voltage of the switching control signal S1 is at a first level (for example, a high level, in volts) such that the first switching units SW1 are turned on, so that the driver device 160 can sequentially output the scan signals S_S to different scan lines 112. During the touch sensing period T2, the voltage of the switching control signal S1 is at a second level (for example, a low level), so that the first switching units SW1 are non-conducting, thereby disconnecting between the driver device 160 and the scan lines 112.

Therefore, during the touch sensing period T2, the connection points between the scan lines 112 and the driver device 160 are in high impedance states, so that the occurrence of different equivalent capacitance values (hereinafter referred to as the capacitance effect) are reduced to reduce affecting the touch sensing result of the electronic apparatus. Therefore, during the touch sensing period T2, the capacitance effect affecting the touch sensing result of the electronic apparatus 100 can be reduced by controlling the non-conducting states of the first switching units

SW1.

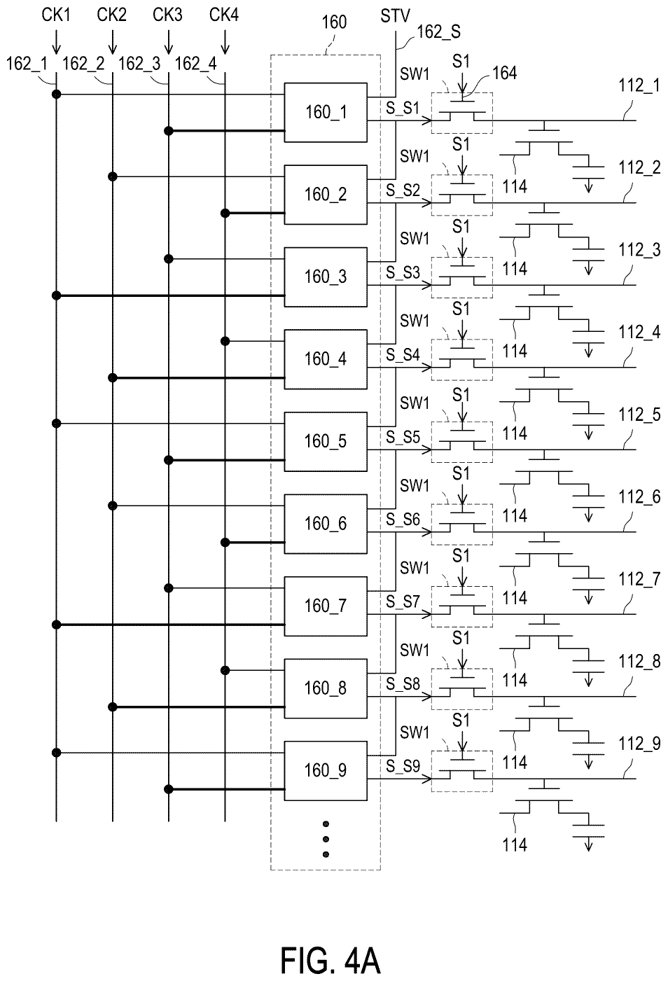

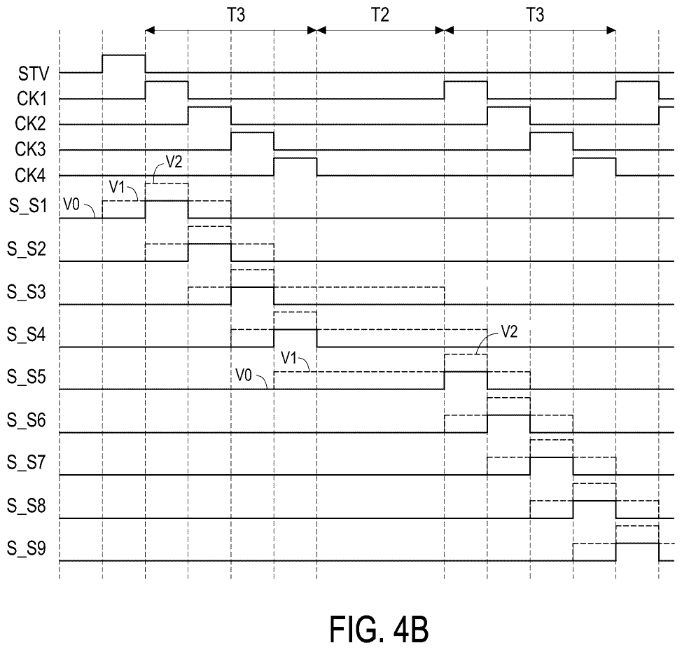

FIG. 4A shows a schematic outline diagram of a driver device of an embodiment of the disclosure. FIG. 4B shows a schematic waveform diagram of signals related to the driver device of the embodiment of FIG. 4A. Referring to FIG. 4A and FIG. 4B, the electronic apparatus 100 includes the driver device 160, and the driver device 160 may include driving units 160_1 to 160_9. The driving units 160_1 to 160_9 are each coupled to scan lines 112_1 to 112_9. The driving units 160_1 to 160_9 output scan signals S_S1 to S_S9 to the scan lines 112_1 to 112_9.

Specifically, in the embodiment, the driving units 160_1 to 160_9 are divided into groups of four. For example, the driving units 160_1, 160_2, 160_3, and 160_4 are in a first group, and the driving units 160_5, 160_6, 160_7, and 160_8 are in a second group.

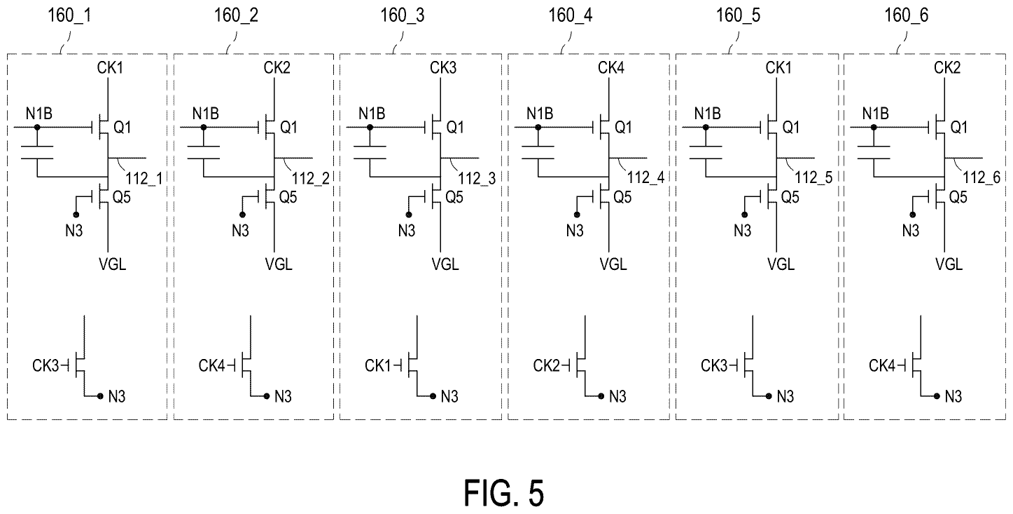

Please refer to FIG. 4A, FIG. 4B, and FIG. 5 at the same time. FIG. 5 shows a schematic diagram of a partial circuit structure of the driving units of the embodiment of FIG. 4A. During the display update period T3 before the first touch sensing period T2, the control element 120 outputs timing signals STV, CK1, and CK3 to the driving unit 160_1 through signal lines 162_S, 162_1, and 162_3 respectively. The driving unit 160_1 generates the scan signal S_S1 for the scan line 112_1 according to the timing signal STV, the timing signal CK1, and the timing signal CK3. In detail, when the timing signal STV is at a high level, a node N1B in the driving unit 106_1 is adjusted to a first high level V1. When the timing signal CK1 is at a high level, the node N1B in the driving unit 106_1 is adjusted to a second high level V2. The voltage value of the second high level V2 is higher than the voltage value of the first high level V1 to turn on a switching unit Q1, so that the driving unit 160_1 sends the timing signal CK1 to the scan line 112_1 as the scan signal S_S1. When the timing signal CK1 returns to the low level, the node N1B in the driving unit 106_1 is adjusted back to the first high level V1 and stops sending the timing signal CK1, that is, the scan signal S_S1 returns to a low level V0, and when the timing signal CK3 is at a high level, a switching unit Q5 will be turned on, and the node N1B in the driving unit 106_1 will be adjusted back to a low level. One end of the switching unit Q5 is coupled to the operating voltage VGL.

Next, the driving unit 160_2 generates the scan signal S_S2 for the scan line 112_1 according to the scan signal S_S1 and by receiving the timing signal CK2 through a signal line 162_2 and the timing signal CK4 through a signal line 162_4. In detail, when the scan signal S_S1 is at a high level, the node N1B in the driving unit 106_2 is adjusted to the first high level V1. When the timing signal CK2 is at a high level, the node N1B in the driving unit 106_2 is adjusted to the second high level V2 to turn on the switching unit Q1, so that the driving unit 160_2 sends the timing signal CK2 to the scan line 112_2 as the scan signal S_S2. When the timing signal CK2 returns to a low level, the node N1B in the driving unit 106_2 is adjusted back to the first high level V1 and stops sending the timing signal CK2, that is, the scan signal S_S2 returns to the low level V0, and when the timing signal CK4 is at a high level, the switching unit Q5 will be turned on, and the node N1B in the driving unit 106_2 will be adjusted back to a low level.

The driving unit 160_3 generates the scan signal S_S3 in a manner similar to the driving unit 160_1, the driving unit 160_4 generates the scan signal S_S4 in a manner similar to the driving unit 160_2, and so on. Therefore, the driving units 160_1 to 160_4 can sequentially generate the scan signals S_S1 to S_S4 to the scan lines 112_1 to 112_4.

Further, please continue to refer to FIG. 4B and FIG. 5. In FIG. 4B, the scan lines 112_1 to 112_9 are scanned sequentially, and the touch sensing period T2 is bounded between the high levels corresponding to the scan signal S_S4 and the scan signal S_S5. Before the start of the touch sensing period T2, when the scan signal S_S4 is at a high level, the node N1B in the driving unit 160_5 will be affected by the scan signal S_S4 and be precharged to the first high level V1, as marked by a dotted line V1 in FIG. 4B. In this way, after the touch sensing period T2 ends, when the timing signal CK1 is at a high level, the node N1B in the driving unit 160_5 will be adjusted to the second high level V2 to turn on the switching unit Q1 so as to send the timing signal CK1 to the scan line 112_5 for generating the scan signal S_S5. When the timing signal CK1 is at a low level, the node N1B will be adjusted back to the first high level V1 and stop sending the timing signal CK1 (that is, the signal level on the scan line 112_5 returns to the low level V0). The voltages of the nodes N1B of the driving units 160_3 and 160_4 will not return to the low level until after the touch sensing period T2 ends and when the timing signals CK1 and CK2 are at high levels. In FIG. 4B, the dotted line waveform on each scan signal is the signal waveform of the node N1B in the driving unit.

Therefore, during the touch sensing period T2, only the voltages of the nodes N1B of the driving units 160_3, 160_4, and 160_5 are at high levels. Therefore, the switching unit Q1 in each driving unit is in a conducting state, and the switching unit Q5 is in a non-conducting state. On the other hand, during the touch sensing period T2, the voltages of the nodes N1B of the other driving units 160_1, 160_2, 160_6, 160_7, 160_8, and 160_9 are at low levels, so the switching unit Q1 is in a non-conducting state, and the switching unit Q5 is in a conducting state.

Therefore, during the touch sensing period T2, for the scan lines 112_3, 112_4, and 112_5, the equivalent capacitance value of the corresponding driving units 160_3, 160_4, and 160_5 is the capacitance value of the switching unit Q1, and for the scan lines 112_1, 112_2, 112_6, 112_7, 112_8, and 112_9, the equivalent capacitance value of the corresponding driving units 160_1, 160_2, 160_6, 160_7, 160_8, and 160_9 is the capacitance value of the switching unit Q5. When the switching unit Q1 and the switching unit Q5 are, for example, thin film transistors, the channel ratio of the semiconductor used in the switching unit Q1 will be different from the channel ratio of the semiconductor used in the switching unit Q5. Therefore, the capacitance values of the switching unit Q1 and the switching unit Q5 are different. In the embodiment, the capacitance value of the switching unit Q1 is greater than the capacitance value of the switching unit Q5.

Since the capacitance values of the switching units Q1 and Q5 are different, the capacitance effects generated by the driving units 160_1 to 160_9 during the touch sensing period T2 will affect the touch sensing result of the electronic apparatus 100. Therefore, during the touch sensing period T2, the first switching unit SW1 can be controlled to be in a non-conducting state and in a high impedance state, so that the connection points between the scan lines 112_1 to 112_9 and the driving units 160_1 to 160_9 are all in high impedance states to reduce the capacitance effect affecting the touch sensing result of the electronic apparatus 100.

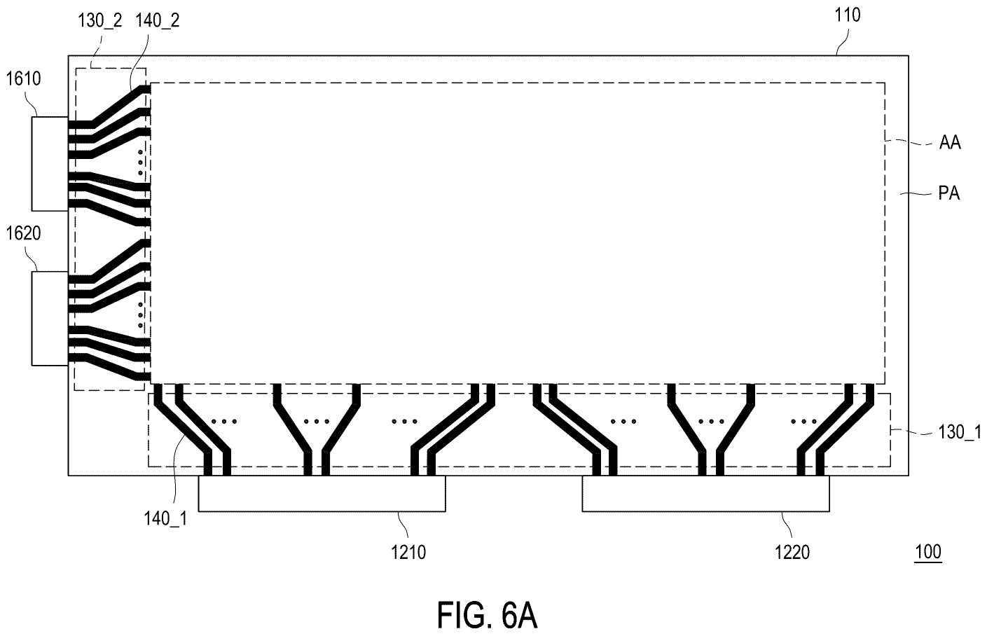

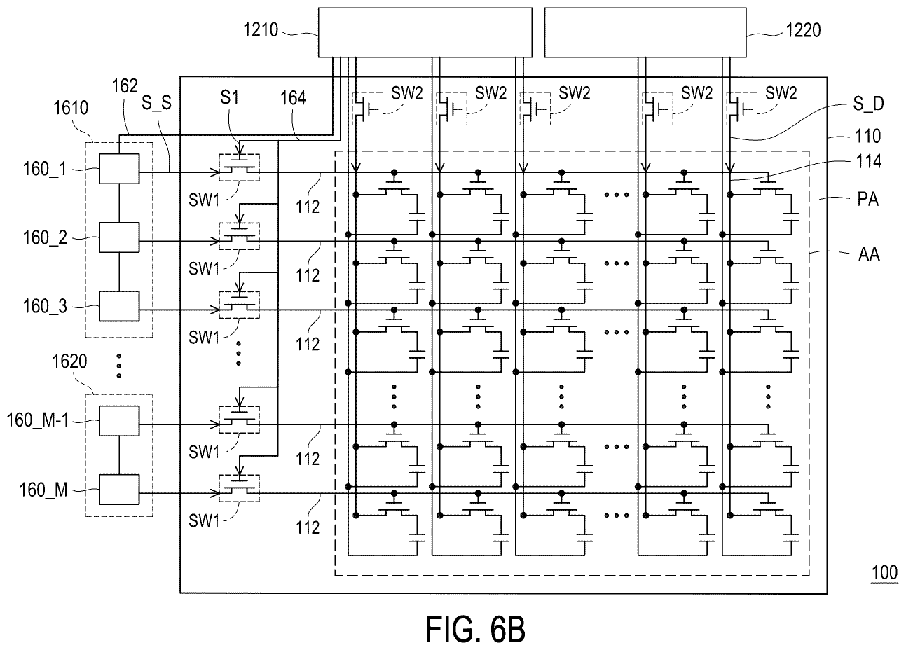

FIG. 6A shows a schematic outline diagram of an electronic apparatus of another embodiment of the disclosure. FIG. 6B shows a schematic circuit diagram of the electronic apparatus of the embodiment of FIG. 6A. Referring to FIG. 6A and FIG. 6B, the electronic apparatus 100 includes a control element 1210 and a control element 1220 and a driver device 1610 and a driver device 1620. In the embodiment, the number of the control elements and/or the number of the driver devices can be increased or decreased according to actual requirements. The control element 1210 and the control element 1220 are integrated circuit chips, which are disposed outside the substrate 110 (that is, not disposed on the substrate 110), and pass through a plurality of signal lines 140_1 on a wiring area 130_1 in the peripheral area PA so as to be coupled to the signal line 114 on the substrate 110. The driver device 1610 and the driver device 1620 can also be integrated circuit chips, which can also be disposed outside the substrate 110 (that is, not disposed on the substrate 110), and pass through a plurality of signal lines 140_2 on a wiring area 130_2 in the peripheral area PA to be coupled to the signal line 112 on the substrate 110. In FIG. 6B, the electronic apparatus 100 further includes a second switching unit SW2 disposed on the substrate 110. The control element 1210 and the control element 1220 are coupled to the signal line 114 through the second switching unit SW2.

Since the control element 1210 and the control element 1220 and the driver device 1610, and the driver device 1620 are respectively coupled to the signal lines 140_1 and the signal lines 140_2 on the wiring area 130_1 and the wiring area 130_2 of the substrate 110, and since the lengths of each signal line 140_2 and each signal line 140_2 are different, the corresponding resistive and/or capacitance load is also different (hereinafter referred to as the load effect). Therefore, during the touch sensing period T2, for the signal line 112 and/or the signal line 114, their corresponding equivalent resistance values and capacitance values are also different.

Therefore, during the touch sensing period T2, the first switching unit SW1 and/or the second switching unit SW2 can be controlled to be in a non-conducting state, so that the connection point between the signal line 112 and the driver device 1610 and the driver device 1620 and/or the connection point between the signal line 114 and the control element 1210 and the control element 1220 are in high impedance states to reduce the load effect affecting the touch sensing result of the electronic apparatus 100.

To sum up, in the embodiment of the disclosure, during touch sensing period, the first switching unit of the electronic apparatus may be non-conducting, so that the connection point between the scan line and the scan line driver is in a high impedance state to reduce the capacitance effect affecting the touch sensing result of the electronic apparatus. In the embodiment with the second switching unit, during the touch sensing period, the first switching unit and the second switching unit can be further controlled to be non-conducting to reduce the load effect affecting the touch sensing result of the electronic apparatus.

Finally, it should be noted that the above embodiments are merely used to illustrate the technical solution of the disclosure, but not to limit the disclosure. Although the disclosure has been described in detail with reference to the embodiments, it should be understood that persons of ordinary skill in the art can still modify the technical solutions recorded in the embodiments or make equivalent substitutions for some or all of the technical features. However, the modifications or substitutions do not cause the essence of the corresponding technical solution to depart from the scope of the technical solution of the embodiments of the disclosure.

What is claimed is:

1. An electronic apparatus, comprising:
a substrate;
a plurality of scan lines, disposed on the substrate; and
a plurality of first switching units, disposed on the substrate,
wherein each of the scan lines is coupled to a driver device through one of the plurality of first switching units.

2. The electronic apparatus according to claim 1, wherein the substrate comprises a peripheral area and an active area, and the plurality of first switching units are disposed in the peripheral area.

3. The electronic apparatus according to claim 1, wherein the driver device is disposed in a peripheral area.

4. The electronic apparatus according to claim 1, further comprising:
a plurality of data lines, disposed on the substrate; and
a plurality of second switching units, disposed on the substrate,
wherein each of the data lines is coupled to one of the plurality of second switching units.

5. The electronic apparatus according to claim 4, wherein the substrate comprises a peripheral area and an active area, and the plurality of second switching units are disposed in the peripheral area.

6. The electronic apparatus according to claim 1, further comprising:
a control element, wherein the driver device is coupled to the control element.

7. The electronic apparatus according to claim 6, further comprising:
at least one touch electrode, disposed on the substrate, wherein the at least one touch electrode is coupled to the control element.

8. The electronic apparatus according to claim 7, wherein when the electronic apparatus operates during a touch sensing period, the plurality of first switching units are non-conducting.

9. The electronic apparatus according to claim 7, further comprising:
a plurality of data lines, disposed on the substrate; and
a plurality of second switching units, disposed on the substrate,
wherein each of the data lines is coupled to the control element through one of the plurality of second switching units.

10. The electronic apparatus according to claim 9, wherein when the electronic apparatus operates during a touch sensing period, the plurality of first switching units and the plurality of second switching units are non-conducting.

11. The electronic apparatus according to claim 6, wherein the control element is an integrated circuit chip.

12. The electronic apparatus according to claim 1, wherein the driver device is disposed outside the substrate and coupled to the substrate.

13. The electronic apparatus according to claim 1, wherein the driver device is an integrated circuit chip.

14. The electronic apparatus according to claim 6, wherein the control element scans from above to below the substrate at a first frequency.

15. The electronic apparatus according to claim 14, wherein the control element scans from two outer sides to an inner side of the substrate at a second frequency.

16. The electronic apparatus according to claim 15, wherein the first frequency is less than the second frequency.

17. The electronic apparatus according to claim 1, wherein the driver device comprises a plurality of driving units, and the plurality of driving units are each coupled to the corresponding scan line.

18. The electronic apparatus according to claim 17, wherein the plurality of driving units are divided into a plurality of groups.

19. The electronic apparatus according to claim 1, wherein the electronic apparatus has a frame period, and the frame period comprises a touch sensing period and a display update period.

20. The electronic apparatus according to claim 19, wherein when the electronic apparatus operates during the display update period, display screen data is updated by region, and when the electronic apparatus operates during the touch sensing period, a touch sensing function is performed by region.
